(19) United States
(12) Patent Application Publication
(10) Pub. No.: US 2022/0009572 A1
(43) Pub. Date: Jan. 13, 2022

(54) LENGTHWISE SPLIT TRAILER

(71) Applicant: SCI Innovations, LLC, Albia, IA (US)

(72) Inventor: Jon J. Rhodes, Albia, IA (US)

(73) Assignee: SCI Innovations, LLC, Albia, IA (US)

(21) Appl. No.: 17/350,220

(22) Filed: Jun. 17, 2021

Related U.S. Application Data
(60) Provisional application No. 63/040,036, filed on Jun. 17, 2020.

(51) Int. Cl. B62D 63/06; B60P 3/34

(52) U.S. Cl. CPC B62D 63/061; B60P 3/34

(57) ABSTRACT

A trailer having two independent longitudinal sections pivotally attached and extending rearward from a front section. Each longitudinal section includes a wheel attached to the section with an independent spindle trailer suspension system. The longitudinal sections are capable of expanding laterally and contracting longitudinally when in a stationary position.

### CROSS-REFERENCE TO RELATED APPLICATIONS

This application claims priority to U.S. Provisional Patent Application Ser. No. 63/040,036 filed on Jun. 17, 2020, the contents of which are being incorporated herein by reference in their entirety.

### FEDERAL SPONSORSHIP

Not Applicable.

### JOINT RESEARCH AGREEMENT

Not Applicable

### TECHNICAL FIELD

The present invention relates generally to trailers pulled behind motor vehicles. More particularly, the present invention relates to a trailer or cart having two lengthwise sections pivotally mounted to a front towing section of the trailer or cart, wherein the two lengthwise sections extend longitudinally and parallel to a lengthwise axis of the trailer or cart. Each lengthwise section is pivotally mounted to the towing section and includes a wheel rotationally mounted to an independent axle or spindle allowing the two lengthwise sections to split and pivot laterally outward.

### BACKGROUND

Over the years pull behind trailers have been used for a variety of reason including transporting other vehicles, hauling a variety of cargo, recreational activities, transporting goods to name just a few. These trailers typically include a frame having a suspended axle fixed to the frame and wheels rotationally attached to opposing ends of the axle. Certain specialized trailers have axle-less trailer suspension systems, however, prior trailers do not include a support frame that is split lengthwise and outwardly rotatable. Further, known trailers may include slide out sections that slide laterally from the lengthwise axis of the trailer, but the slide outs slide on rails and do not pivot and extend rotationally laterally outward.

Further, although use of a trailer during recreational activities such as tailgating, camping, picnics and similar types of outdoor activities are well-known in the art, typically, the trailer must be loaded prior to using it and then unloaded after the activity. Further, not only does the loading of these items take time, but once one arrives at a desired location, all items need to be unloaded for use. When the activity is over, the items are reloaded, only to be unloaded once again when home is reached. The whole process, in addition to being inconvenient, is time consuming and labor intensive.

Although camping trailers and other utility trailers may have externally accessible compartments, the present invention includes multiple compartments that reduce set-up and unload time for recreational activities. Also, the trailer of the present invention allows items to be neatly stored but accessible without unloading. At the end of the day, the trailer of the present invention may be folded up without the need to pack the trailer. When arriving back home, there would be no need to unpack immediately. Such a device is desired in the art.

### SUMMARY

Embodiments according to aspects of the invention provide a lengthwise split trailer that hitches or mounts to a car, truck, SUV, tractor or other motorized vehicle. An embodiment in accordance with the present invention includes a towable “has all” recreational trailer equipped with a built in cooler, grill and dry food storage. The trailer pivots open and out for up to 8 bench seat positions and 8 stand up or bar stool spots. The trailer may be utilized in many situations including use in a stadium parking lot or the sand bar of your favorite fishing spot.

By way of example, the trailer may measure approximately 5 feet wide and have a length of 11 feet measured from the back end to the front of the front storage unit. Those skilled in the art will appreciate that the trailer of the present invention may be constructed with a heavy durable framework and multiple tandem wheels on each side of the lengthwise split without departing from the scope of the invention. Further, without limitation, the framework and support structure may be constructed from tube steel, aluminum or other known suitable material. Sheet metal or other material may be riveted or otherwise attached to the framework. Dependent upon the materials used, the lengthwise split trailer of the present invention may be made to weigh under 1000 pounds and tow easily behind a motor vehicle. Some of the key benefits of the trailer in accordance with the present invention include relatively a light weight framework, user friendly, accessible storage, easy load/unloading, lockable, outer accessible storage area, trail ready, customizable, and versatile. Without limitation intended the lengthwise split trailer of the present invention may be useful for tailgating sporting events, fishing/camping trips, family outings to anywhere, celebrations/concerts, charity events/picnics, company events/job sites, backyard/local park, hiking/rock climbing, or travelling the country.

In an exemplary embodiment of the invention the device includes a trailer for towing behind a motorized vehicle that expands laterally and contracts longitudinally when in a stationary position. The trailer includes a front section member, first and second longitudinal members and first and second wheels. The front section member has a hitch point for coupling to a vehicle. The front section member also has first and second opposing ends wherein a distance between the opposing ends defines a width of the front section member. The first longitudinal section member pivotally joins to the front section member at the first end of the front section member and at a forward end of the first longitudinal member. Similarly, the second longitudinal section member pivotally joins to the front section member at the second end of the front section member and at a forward end of the second longitudinal member. The first wheel is rotationally attached to the first longitudinal section member and the second wheel rotationally attached to the second longitudinal section member.

In accordance with aspects of the invention the exemplary embodiment of the invention may further include a first bench mounted to the first longitudinal section member. Further, a second bench may be mounted to the second longitudinal section member. A first folding table may be attached or mounted with a hinge to the first longitudinal section member. Likewise, a second folding table may be mounted to the second longitudinal section member. A propone cook top may be mounted to the front section member. Also, a flexible cover is mounted to the front section member wherein the cover is capable of covering a top of both the first and second longitudinal section members when the trailer is in a stowed orientation. The front section member may further include a cooler contained in the front section member. Adjustable height jack stands may be mounted to the opposing first and second ends of the front section member. Further, swing jacks may be mounted to the front and back of the trailer. The first and second wheels may be mounted with an axle-less trailer suspension system. Latches may secure the first longitudinal section member and the second longitudinal section member together. Additionally, the first and second longitudinal section members may include engagement edges to engage together and interlock the two sections together.

In an embodiment of the invention the device includes a trailer having three main components or sections; a main frame, a left bench frame and a right bench frame. A two inch trailer coupler is bolted to a 2 in square tube that is welded directly into the center of the main frame. Hinges used on the trailer to interconnect the left and right bench frames to the main frame are of known suitable construction. An exemplary hinge is part number H1032LH-10 available from Sierra Pacific, Inc. Two hinges are welded on each opposing end of the main frame. Each pair of hinges are space apart a distance of 25% inches from the vertical center of each end of the main frame. The other end of each hinge is aligned and welded to a corresponding outside front end of each left and right bench frames. In this manner the bench frames are aligned to each at the same height relative to the main frame and may pivot outward with little resistance. The left and right bench frames measure 60 inches in length and 23⅞ inches wide. Thus, the outside of left and right side frames are aligned at a measurement of 48 inches outside to outside. A gap of ¼ inch between the two moving sides is taken up by a water and chemical resistant rubber seal that eliminates any movement between the opposing sides when the trailer is being towed.

The two frames when closed are a rectangle shape of 48 by 60 inches which in turn allows axle-less trailer suspension system placement on each bench frame to be perfectly placed in line with each other on opposite sides of the trailer. Tires or wheels coupled to a spindle of each the suspension systems positively align with center of trailer. An exemplary axle-less suspension system is available from Timbren Industries which may be bolted or welded to a support on each of the bench frames. Mounting of suspension systems may be accomplished with with (6) ⅜ grade 8 bolts using a lock washer, Loctite and torqued to manufacturer's specs of 23 ft lbs. The support plate is ½ inch thick and is drilled and threaded for the bolts for easy install. Both plates are welded 14 inches from the front of each bench frame and placed perfectly square to each frame making the spindles of opposing systems mounted linear along a rotation axis for the wheels. The trailer tires are bolted to 5 lugs on a hub, wherein the tires rotate in parallel with the trailer.

In order to hold everything in place at the end of the sides where the seam meets there are 2 spring loaded draw latches (2133BK-L Sierra Pacific part) bolted with (4) ¼ screws to a threaded plate that is welded to the left side frame. Locking mechanism is built within that latch. A basic loophole for a ⅜ pin may be inserted to ensure latch cannot become unhooked. Once the bench frames are pivoted closed and locked together an aluminum bar is placed at the rear end of the two bench frames for placement of the cover. The aluminum bar provides additional support to the bench frames sides.

The accompanying drawings, which are incorporated in and constitute a portion of this specification, illustrate embodiments of the invention and, together with the detailed description, serve to further explain the invention. The embodiments illustrated herein are presently preferred; however, it should be understood, that the invention is not limited to the precise arrangements and instrumentalities shown. For a fuller understanding of the nature and advantages of the invention, reference should be made to the detailed description in conjunction with the accompanying drawings.

### DESCRIPTION OF THE DRAWINGS

In the various figures, which are not necessarily drawn to scale, like numerals throughout the figures identify substantially similar components. The substantially similar components are illustrated in the various views and multiple Figures may be referenced in association with a particular component.

FIG. 1 is a side perspective view of a trailer having lengthwise split sections in accordance with the present invention and shown in a towable orientation;

FIG. 2 is a side perspective view of a trailer having lengthwise split sections in accordance with the present invention and shown in an open orientation;

FIG. 3 is a front perspective view of a trailer having lengthwise split sections in accordance with the present invention and shown in a towable orientation;

FIG. 4 is a side perspective view of a trailer having lengthwise split sections in accordance with the present invention and shown in a towable orientation;

FIG. 5 is a back side perspective view of a trailer having lengthwise split sections in accordance with the present invention and shown in a towable orientation;

FIG. 6 is a back perspective view of a trailer having lengthwise split sections in accordance with the present invention and shown in a towable orientation;

FIG. 7 is a partial sectional back perspective view of a trailer having lengthwise split sections in accordance with the present invention and shown in a towable orientation;

FIG. 8 is a partial sectional back perspective view of a trailer having lengthwise split sections in accordance with the present invention and shown having a rear swing jack extended;

FIG. 9 is a partial sectional side perspective view of a trailer having lengthwise split sections in accordance with the present invention and showing the cover extending over the split sections;

FIG. 10 is a partial sectional side perspective view of a trailer having lengthwise split sections in accordance with the present invention and showing the cover removed from the split sections;

FIG. 11 is a partial sectional side perspective view of a trailer having lengthwise split sections in accordance with the present invention and showing the cover rolled to a forward end of the split sections;

FIG. 12 is a partial sectional end perspective view of a trailer having lengthwise split sections in accordance with the present invention and showing the cover rolled to a forward end of the split sections;

FIG. 13 is a partial sectional end perspective view of a trailer having lengthwise split sections in accordance with the present invention and showing the cover rolled to a forward end of the split sections;

FIG. 14 is a partial sectional side perspective view of a trailer having lengthwise split sections in accordance with an embodiment of the present invention and showing the trailer in a parked orientation and having components removed for clarity;

FIG. 15 is a partial sectional side perspective view of the trailer of the type shown in FIG. 14;

FIG. 16 is a partial sectional bottom perspective view of the trailer of the type shown in FIG. 14;

FIG. 17 is a partial sectional perspective view of an interior portion of a front portion of a lengthwise split section of a trailer in accordance with an embodiment of the present invention;

FIG. 18 is a partial sectional perspective view of an interior portion of a side portion of a lengthwise split section of a trailer in accordance with an embodiment of the present invention;

FIG. 19 is a side perspective view of a trailer having lengthwise split sections in accordance with an embodiment of the present invention and shown in an open orientation;

FIG. 20 is a side perspective view of a trailer having lengthwise split sections in accordance with the present invention and shown in an open orientation;

FIG. 21 is partial sectional end perspective view of a trailer having lengthwise split sections in accordance with the present invention and shown in a partially open orientation;

FIG. 22 is an end perspective view of a trailer having lengthwise split sections in accordance with the present invention and shown in an open orientation;

FIG. 23 is a partial sectional front perspective view of a trailer having lengthwise split sections in accordance with an embodiment of the present invention and showing the trailer in a parked orientation and having components removed for clarity;

FIG. 24 is a partial sectional bottom perspective view of the trailer of the type shown in FIG. 23;

FIG. 25 is a partial sectional upper side perspective view of the trailer of the type shown in FIG. 14 and shown having the cover remover;

FIG. 26 is a partial sectional lower front perspective view of the trailer of the type shown in FIG. 14;

FIG. 27 is a side perspective view of a trailer having lengthwise split sections in accordance with an embodiment of the present invention and shown in an open orientation;

FIG. 28 is a front perspective view of a trailer having lengthwise split sections in accordance with an embodiment of the present invention and shown in a towable orientation;

FIG. 29 is a partial sectional upper perspective view of a front portion of a trailer in accordance with an embodiment of the present invention;

FIG. 30. is a partial sectional perspective view of a gas line of a cook stove of a trailer in accordance with an embodiment of the present invention;

FIG. 31 is a partial sectional side perspective view of a trailer in accordance with an embodiment of the invention showing the table in a stowed position;

FIG. 32 is a partial sectional side perspective view of a trailer in accordance with an embodiment of the invention showing the hinges of the lengthwise split sections of the trailer;

FIG. 33 is a partial sectional perspective view of a trailer in accordance with an embodiment of the invention showing the inside portion of the hinge of a lengthwise split section and shown in an open position;

FIG. 34 is partial sectional perspective view of an inner side portion of an adjustable jack stand of a trailer in accordance with an embodiment of the invention;

FIG. 35 is a partial sectional perspective view of a trailer in accordance with an embodiment of the invention showing the inside portion of the hinge of a lengthwise split section and shown in an open position;

FIG. 36 is partial sectional perspective view of an outer side portion of an adjustable jack stand of a trailer in accordance with an embodiment of the invention and shown in an extended position;

FIG. 37 is a partial sectional perspective view of a latch of a table of a trailer in accordance with an embodiment of the invention;

FIG. 38 is a partial sectional perspective view of a support of a table of a trailer in accordance with an embodiment of the invention;

FIG. 39 is a partial sectional perspective view of a support of a table of a trailer in accordance with an embodiment of the invention;

FIG. 40 is a partial sectional perspective view of an outer portion of a latch of a storage compartment of a trailer in accordance with an embodiment of the invention;

FIG. 41 is a partial sectional perspective view of an inner portion of a latch of a storage compartment of a trailer in accordance with an embodiment of the invention;

FIG. 42 is a partial sectional perspective view of a hinge of a storage compartment of a trailer in accordance with an embodiment of the invention; and

FIG. 43 is a partial sectional perspective view of a post adaptable for receiving a portion of a picnic umbrella of a trailer in accordance with an embodiment of the invention.

### DETAILED DESCRIPTION

The following description provides detail of various embodiments of the invention, one or more examples of which are set forth below. Each of these embodiments are provided by way of explanation of the invention, and not intended to be a limitation of the invention. Further, those skilled in the art will appreciate that various modifications and variations may be made in the present invention without departing from the scope or spirit of the invention. By way of example, those skilled in the art will recognize that features illustrated or described as part of one embodiment, may be used in another embodiment to yield a still further embodiment. Thus, it is intended that the present invention also cover such modifications and variations that come within the scope of the appended claims and their equivalents.

Generally, the multi-purpose trailer of the present invention includes a frame supported by transport members such as wheels or the like. In an embodiment of the invention the multi-purpose trailer is 5 feet wide, 11 feet long, and has a capacity of 1,000 pounds when fully loaded. The frame has a first end, a second end, a first side and a second side. The transport members (wheels) are rotatably mounted to each side and of the frame. The first end of the frame has a connection member such as a hitch for connecting the trailer to a vehicle. The vehicle may be of any type such as an automobile, truck, motorcycle, tractor, or the like. The sides of the frame have a first section that extends from the connecting member to a hinge point, and from the hinge point to the rear or second end. Mounted to and above the frame, between the connecting member and the hinge point is a first container or compartment. The compartment has a top wall, side walls, end walls, and a bottom wall that form an inner chamber. The inner chamber is separated into sub-chambers by internal separating walls. The sub-chambers include one for dry and/or warm food storage, a second for cold food storage, and a third for a cooking apparatus 48 such as a grill, a smoker, or the like. The cold food storage may include insulation along the side walls and the internal separating walls. Also, each sub-chamber has an opening in the top wall and may have a door with a lock.

Mounted to and above the frame, between the hinge point and the second end, and to each side of the frame are second and third compartments. The second and third compartments have a first or front edge, a second or rear end wall, an outer side wall that extends between the front edge and second end wall, inner edge, a bottom wall and a slidable or rolling cover that slides or rolls along a top edge of the second end wall. The compartments mirror one another and, in a closed or transport position, engage one another along the inner edge.

Disposed within the second and third compartments are seating devices such as a bench, chairs, or the like. Preferably, seating capacity for eight is provided. When in the closed transport position, the second and third compartments permit storage of additional items such as tents, chairs, stools, fishing poles and the like.

In one embodiment a table or shelf extends from a side wall of the first compartment toward the second end of the frame. Preferably the table is positioned adjacent the frame at the bottom of the first compartment and is triangular in shape. The front edge is preferably angled to align with and engage the triangular shape of the table. Attached to the outer side wall of each of the second and third compartments are jacks. The jacks, while raised in a closed transport position, are used to support the trailer when not attached to a vehicle. Pivotally attached to the rear end wall of both the second and third compartments are a second set of jacks. These jacks, as will be explained, include a transport member such as a wheel. Mounted to an outer surface of the rear end walls are brackets. The brackets are used to lock the second and third compartments together in the closed transport position. Also, in one embodiment, an awning either can be raised from or attached to the second and third compartments to provide shade.

In operation, the trailer is transported, in the closed transport position, to a desired location. Once at the desired location, the adjustable height jack stands are lowered to contact the ground. A front swing back jack is used to disconnect the trailer from the vehicle. The front jack is then lowered so that the trailer wheel pivot up and off the ground. The back trailer sections are moved to an open, non-transport position. Rear swing back jacks are then lowered to stabilize the back sections and provide stability to the benches.

Alternatively, to move the trailer to the open non-transport position, the rear jacks are provided with wheels instead of pads and are pivoted from a generally horizontal position to a generally vertical position. The jacks are extended until the jack wheels engage a ground surface. Any apparatus that has been used to lock the second and third compartments together using the brackets are removed. The second and third sections, which are hingedly connected to the first compartment at the first edge, are separated by manually moving the compartments apart at the rear end wall as the jack wheels move across the ground surface. When separated, looking from above, the compartments or sections form a Y-shape. The forward adjustable height jack stands are then lowered to engage the ground surface, and the trailer may, if desired, be removed from the vehicle. Each section may have a separate cover or a single cover the width of the trailer may be used to cover the rear compartments or sections when the trailer is in a towable orientation. The covers may be slid outwardly away from the second and third compartments to provide counter/bar/table top space. A propane tank, preferably connected to the first section of the frame, is connected to the cooking apparatus.

In the various figures the following reference numerals are used throughout to identify the following components:
10—a multi-purpose trailer
20—a frame
22—a first end of frame
24—a second end of frame
26—a tongue member of the frame
28—frame bracing for compartments
30—spindle attachment reinforcement
32—first vertical support for hinge mount
34—second vertical support for hinge mount
36—bracing for enclosure
40—wheels
42—dust cover over spindle suspension
44—axle-less trailer suspension system
46—fenders
48—safety chains
50—hitch/coupling
52—swing back hinge coupled to tongue
56—rear swing back hinges
60—front section member
62—front triangular ledge
64—bracket for propane tank
66—propane tank
68—hose for propane tank
70—first compartment
72—storage door
74—cook stove
76—conduit to stove
78—stove lid
80—second compartment
84—cooler lid
88—door latch
90—hinges for lid
92—lock
94—latch
96—interior triangle flooring section or table
98—flange stop or ledge
100—second section
102—sidewall
104—flooring
106—bracing for spindles
108—lengthwise beams
110—top offset hinge
112—bottom offset hinge
114—vertical support
116—light mount
118—back end of trailer section
120—bracket for bench
124—sealing edge
126—stop
130—top latch half
132—bottom latch half
150—second section
152—sidewall
154—flooring
156—bracing for spindles
158—lengthwise beams
160—top offset hinge
162—bottom offset hinge
164—vertical support
166—light mount
168—back end of trailer section
170—bracket for bench
174—sealing edge
176—stop
180—top latch half
182—bottom latch half
200—table support
202—hinge
204—hook for securing strap
206—securing strap
208—folding table supports
210—hinge for table supports
250—bench
252—bench seat
254—bench back
300—cover
302—side rails
304—back rail
306—canopy or cover roll
308—cover bracing
330—umbrella coupling or post
350—trailer lights
352—wiring
370—adjustable height jack stand
372—pin
374—securing clip
376—inner tube
378—outer stationary tube
380—bottom pad

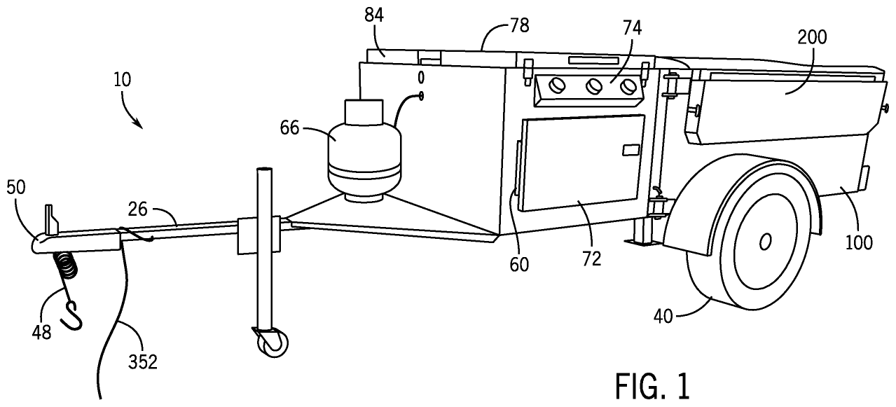

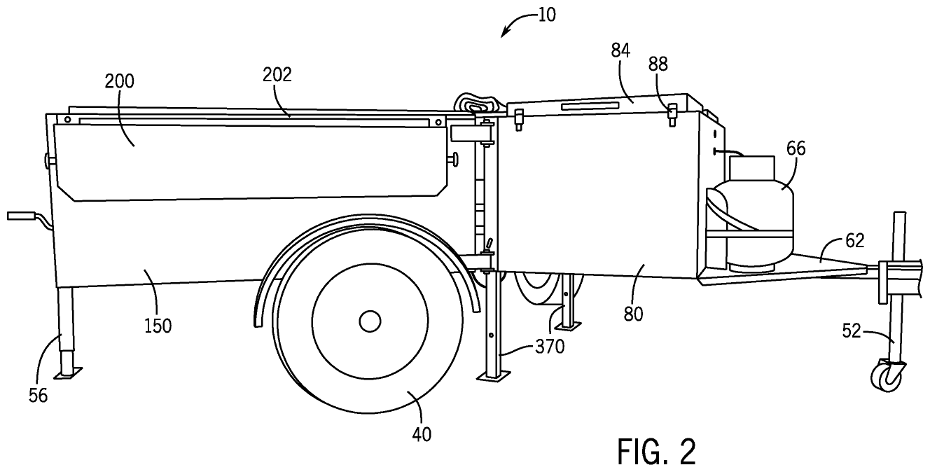

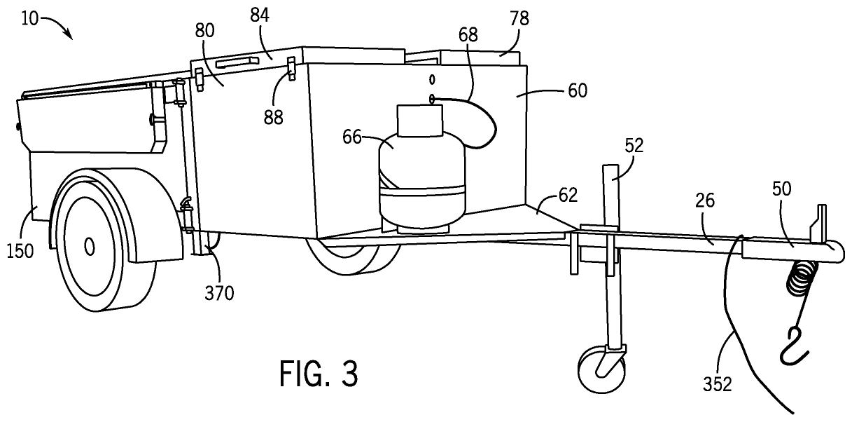

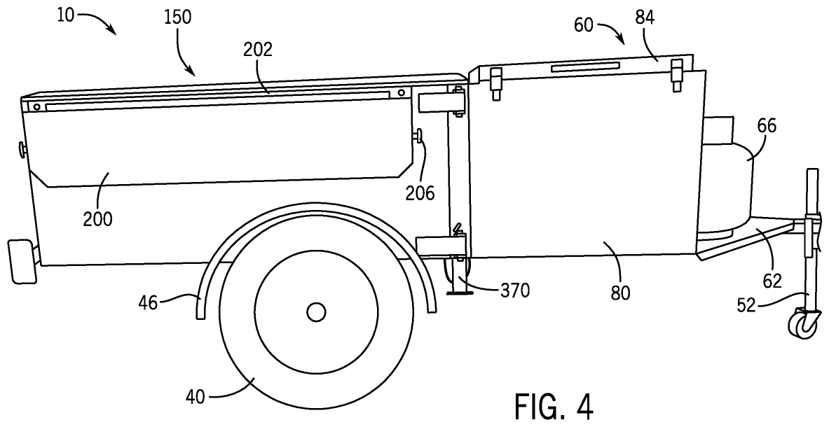

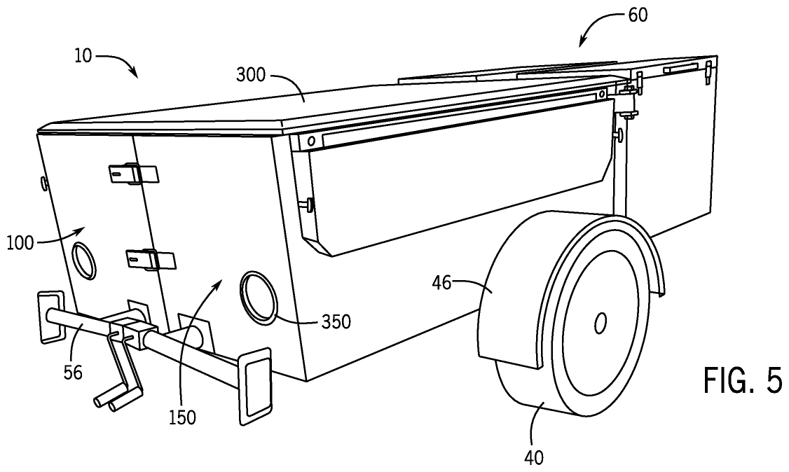

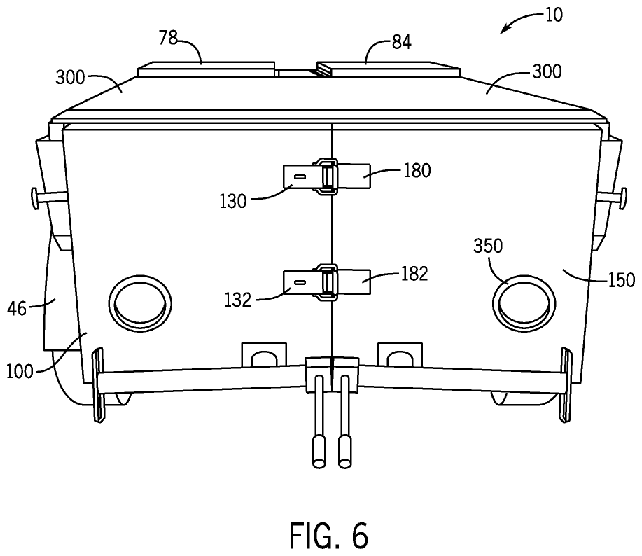

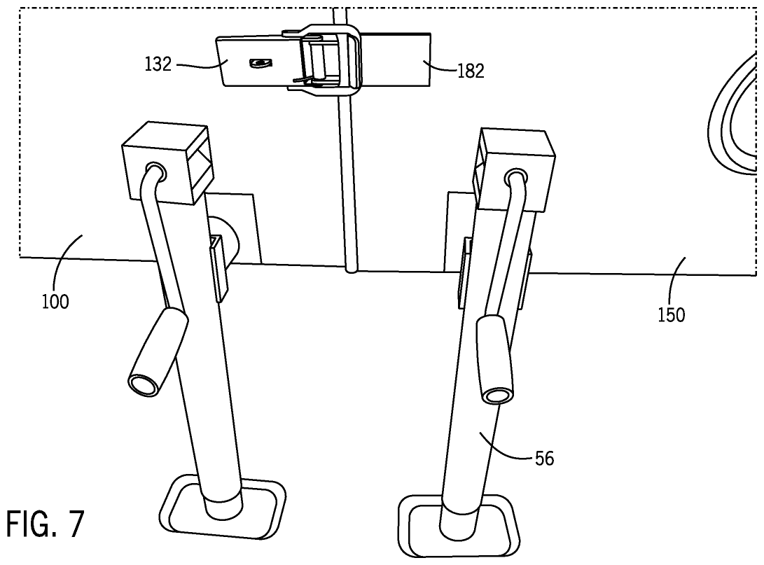

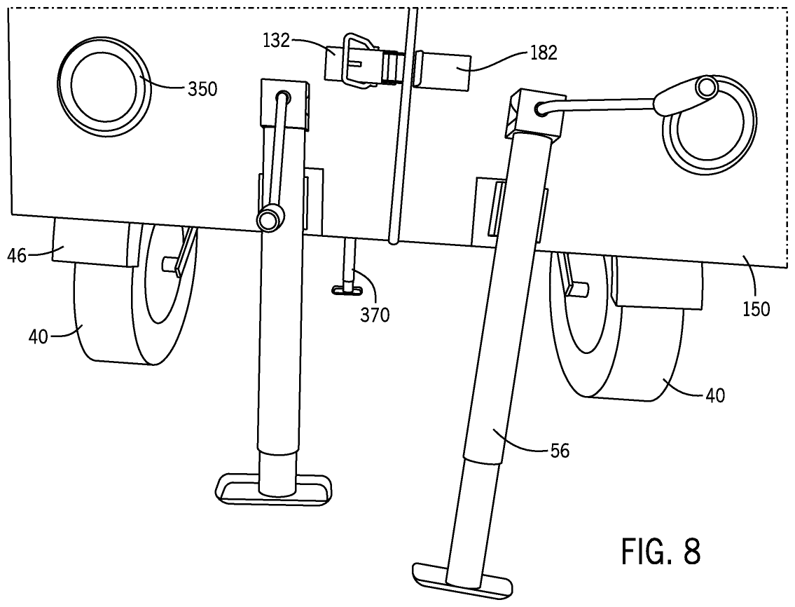

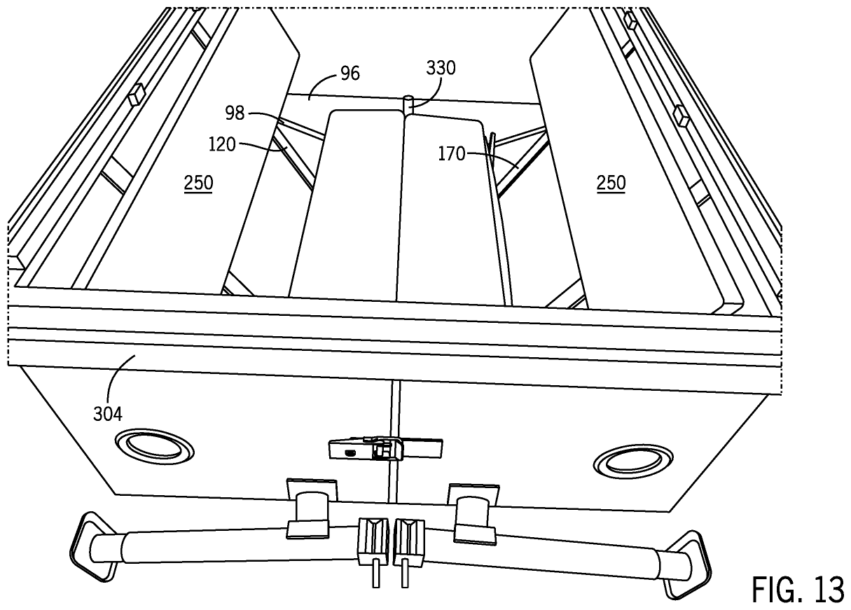

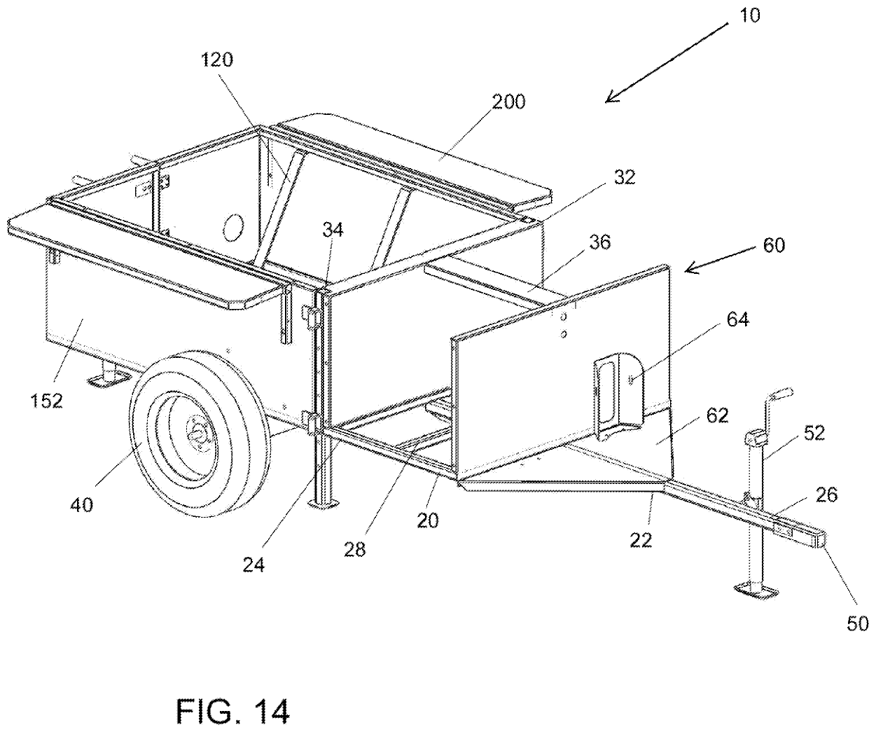

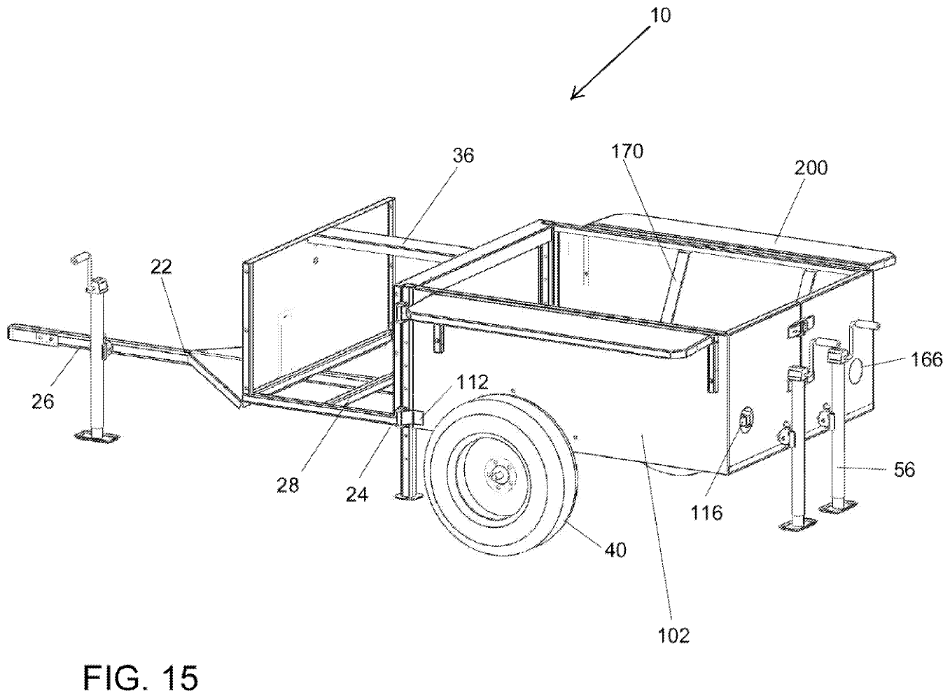

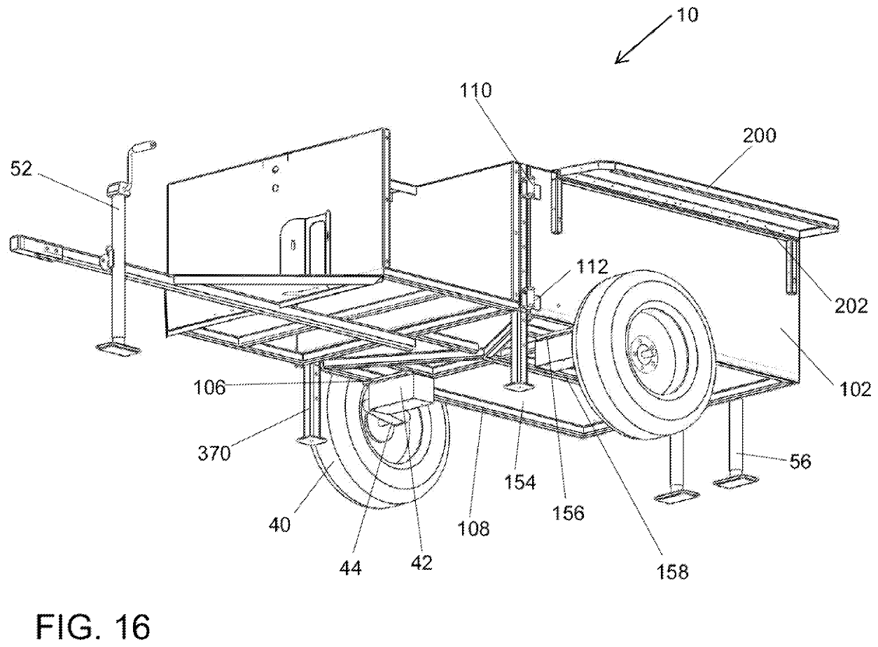

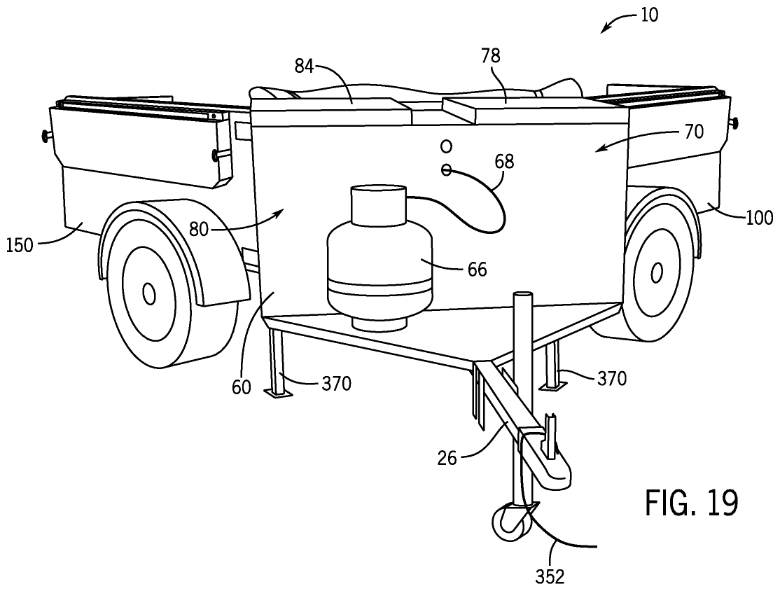

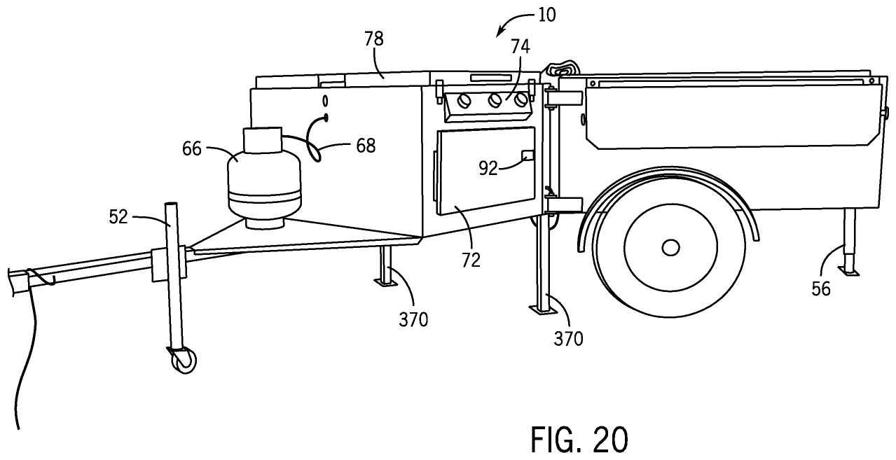

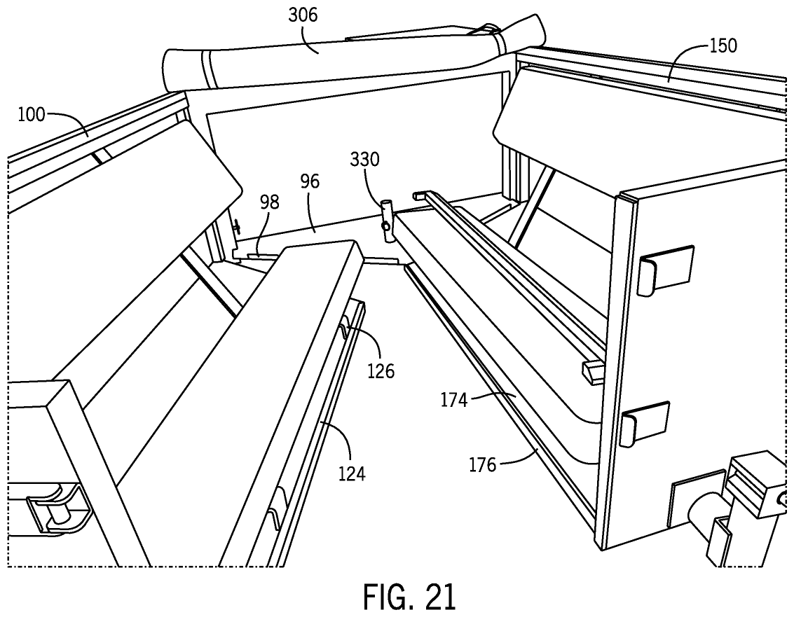

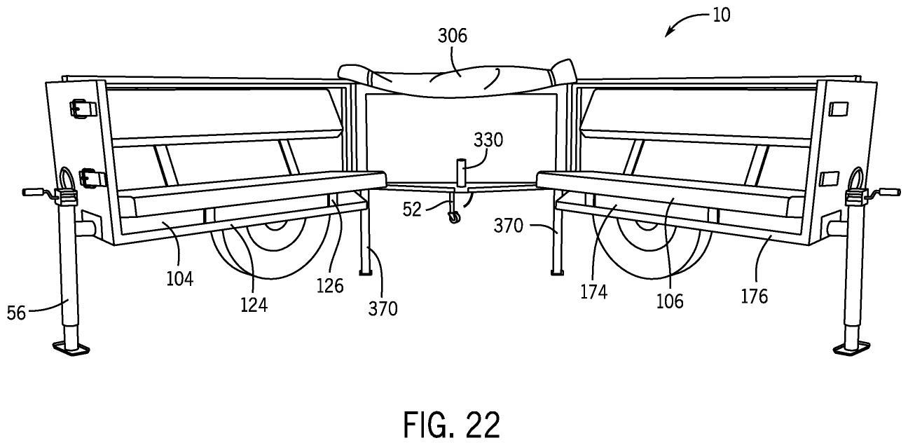

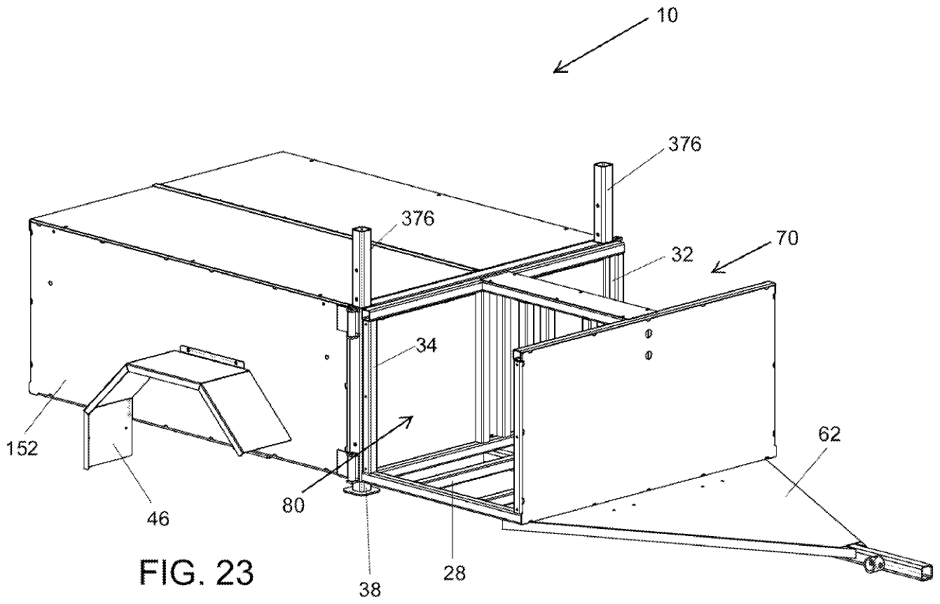

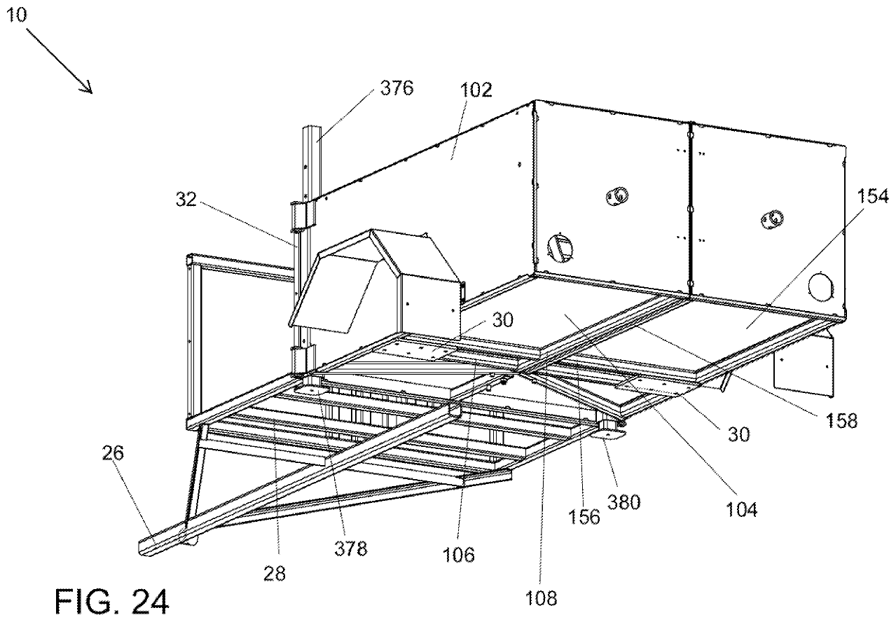

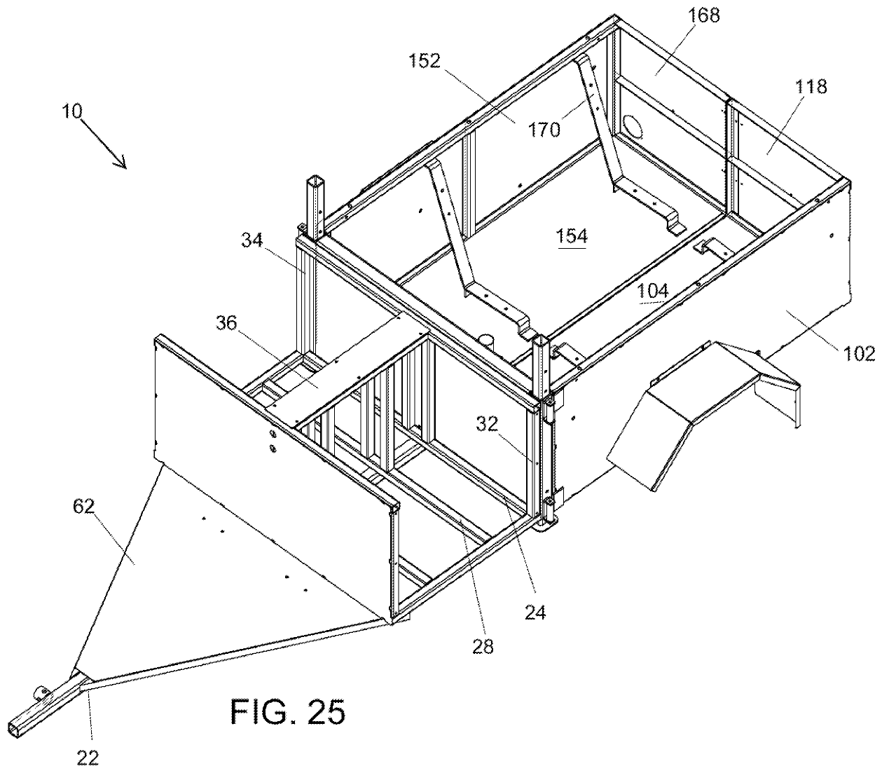

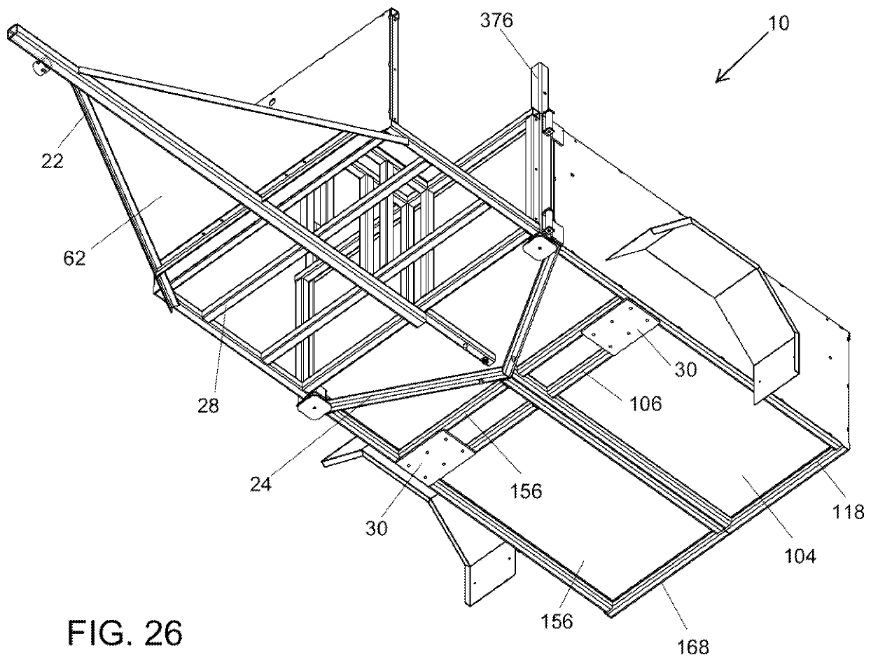

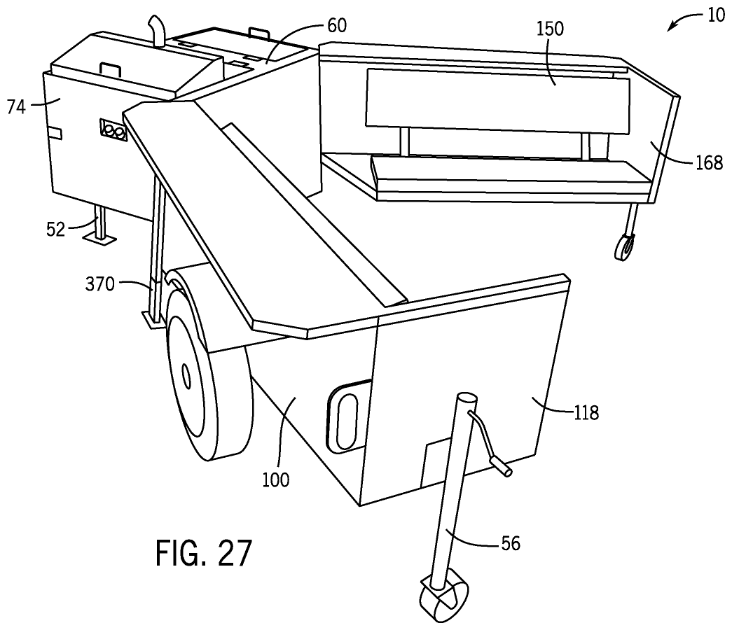

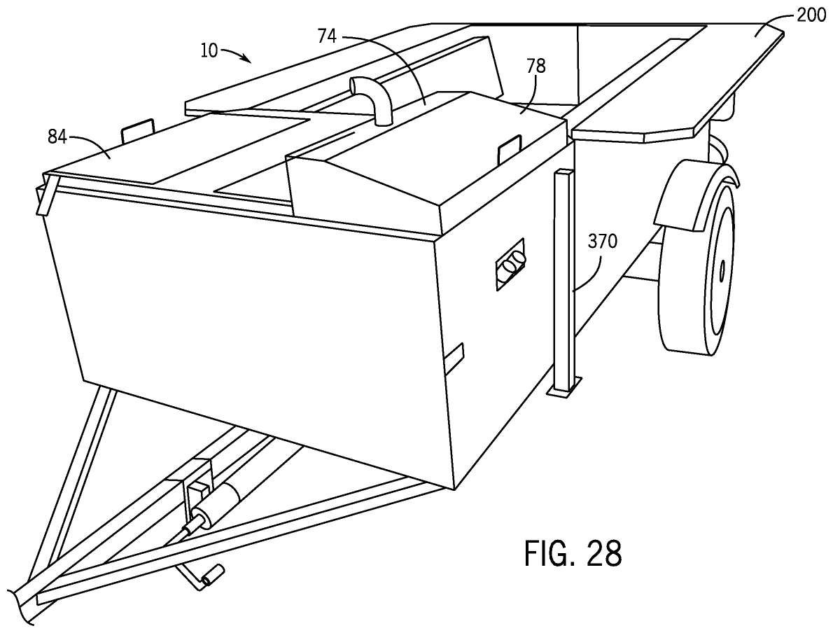

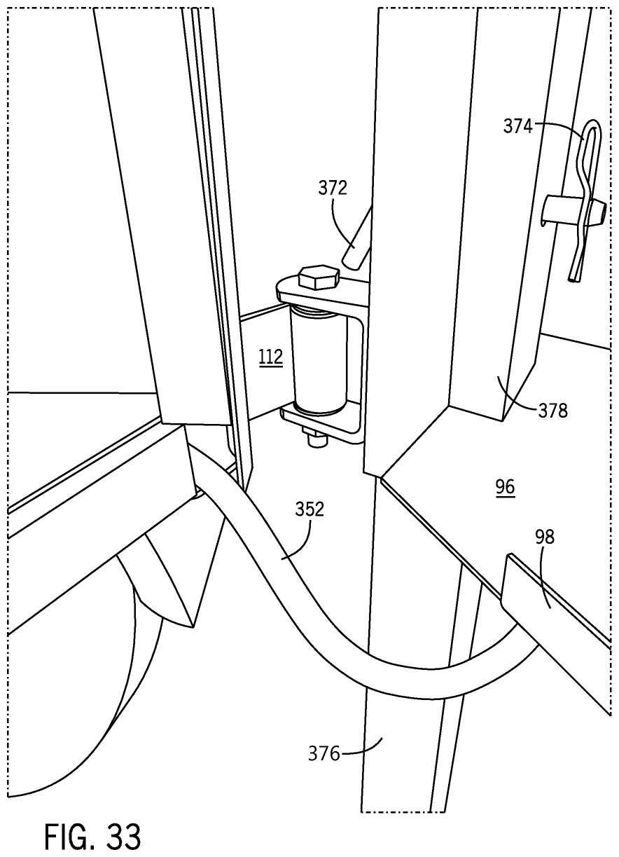

With reference to the Figures, various embodiments and components of the multi-purpose trailer 10 according to aspects of the invention will be described in greater detail. Embodiments of the trailer 10 in accordance with the present invention are shown in the closed or towing position in FIGS. 1-16, 23-26 and 28. Further, embodiments of the trailer 10 in accordance with the present invention are shown in various open orientations in FIGS. 19-22 and 27. With reference to these Figures, the trailer 10 includes a front section 60 and opposing side sections 100 and 150. The front section 60 is built on frame 20 (see FIGS. 14-16). The frame includes a front end 22 and second rearward end 24. Tongue 26 is fixed to the frame 20 and extends from the first end of the frame 22 and terminates at a free end. A hitch or coupling 50 is fixed to the free end of the tongue. Safety chains 48 are also fixed to the free end of the tongue 26. A free end of the trailer wiring 352 also extends from the free end of the tongue. The wiring is routed through hollow tubing of the frame 20 to the trailer lights 350 mounted to the back of the trailer 10 (see also FIG. 33).

Bracing 28 is fixed to the frame 20 to provide further support to compartments positioned on the frame. Spindle attachment reinforcement 30 is fixed to an underside of each side section 100 and 150. First and second vertical supports 32 extend upward from the frame and provide rigidity for mounting the offset hinges. Additional bracing 36 provides additional structural integrity for components fixed to the frame. Fenders 46 mount to the sidewalls 102 and 152 of respective side sections 100 and 150. The fenders 46 cover a top portion of wheels 40 to reduce an amount of debris and road spray flung onto the sides of the trailer.

Axle-less trailer suspension systems 44 are mounted to spindle attachment reinforcement plates 30. Also attached to the free end of tongue 26 is a swing back jack 52. The jack pivots between two locking positions—the towing position and the trailer support or stowed position. The jack includes a handle to extend or retract an inner support from the jack. Rear swing jacks are mounted to each rear end of the second and third sections 100 and 150.

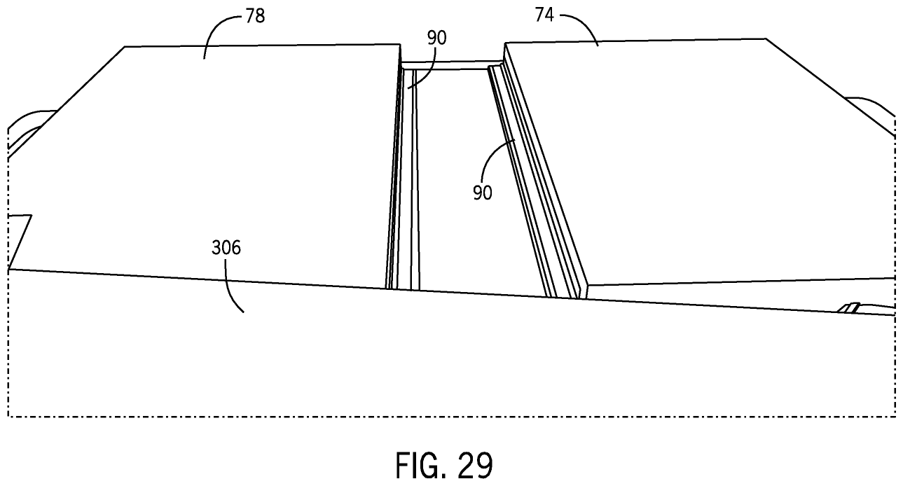

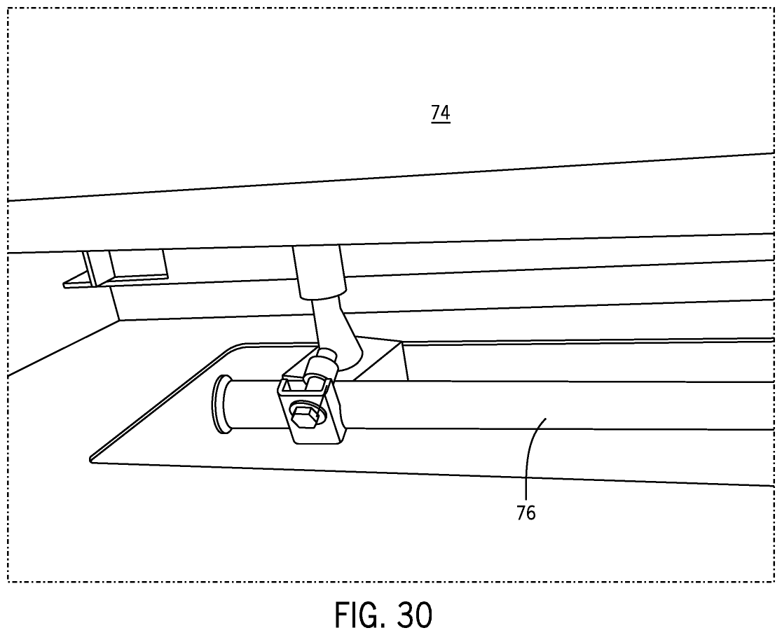

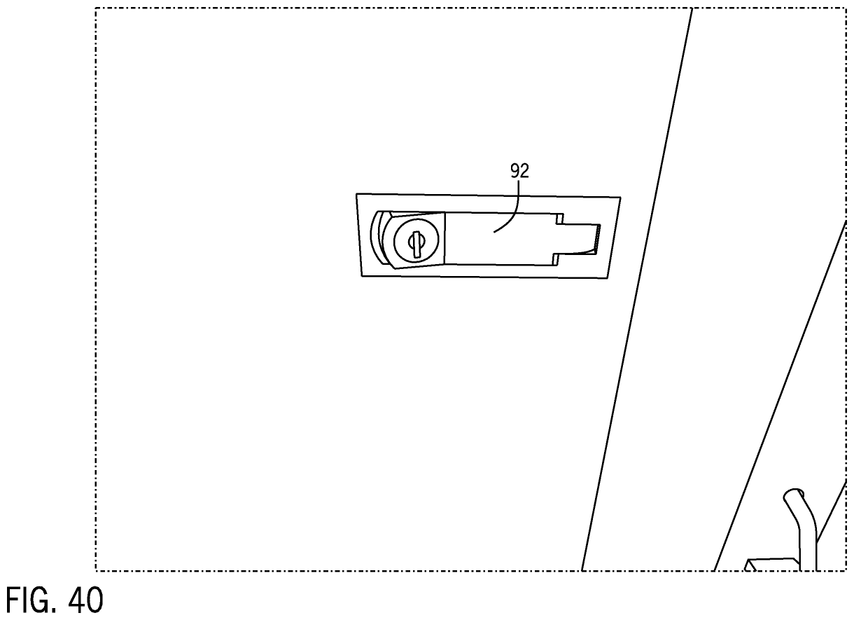

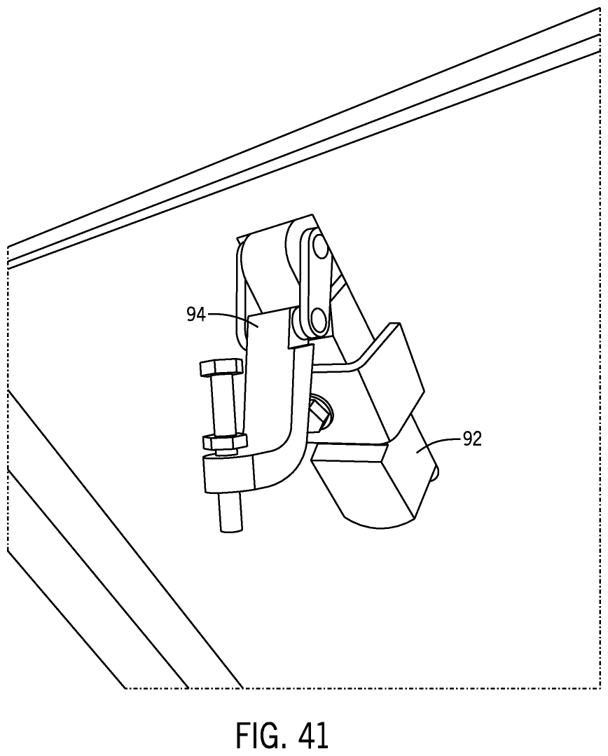

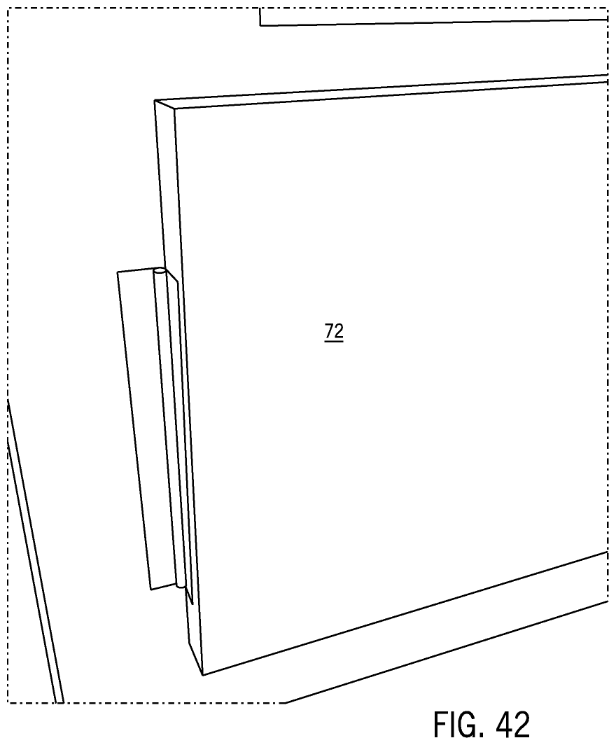

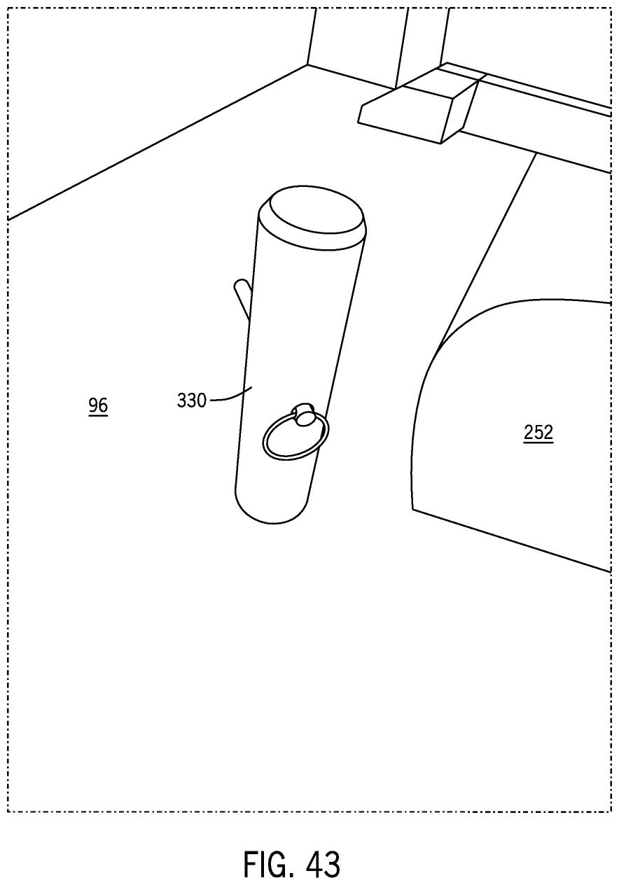

Front section 60 includes a front triangular ledge 60 and a front sidewall extending upward from the ledge. Bracket 64 is attached to the sidewall and is suitable for securing propane tank 66 to the sidewall. A propane hose 68 extends from the tank into a first compartment 70. Storage door 72 provides access to the first compartment 70 (see also FIG. 42). Cook stove 74 is fixed to an upper portion of the first compartment 70. The cook stove 74 may be of a known suitable construction and includes a lid or cover 78. Propane conduit 76 couples the propane hose 68 to the stove 74 (see also FIG. 30). Second compartment 80 is suitable for storage or containing a cooler. Lid 84 provides access into the compartment. Both lids 78 and 84 are fixed to a top of the compartments with a hinge 90 (see also FIG. 29). The storage door 72 includes a door latch 88. The latch includes an outer lock 92 and inner latch 94 (see also FIGS. 40 and 41). An interior triangular flooring or ledge 96 is formed rearward of the compartments 70 and 80 on frame 20. An edge of the flooring 96 includes a flange stop 98 that engages front end of the second and third sections 100 and 150 when the sections are pivoted closed (see also FIG. 43).

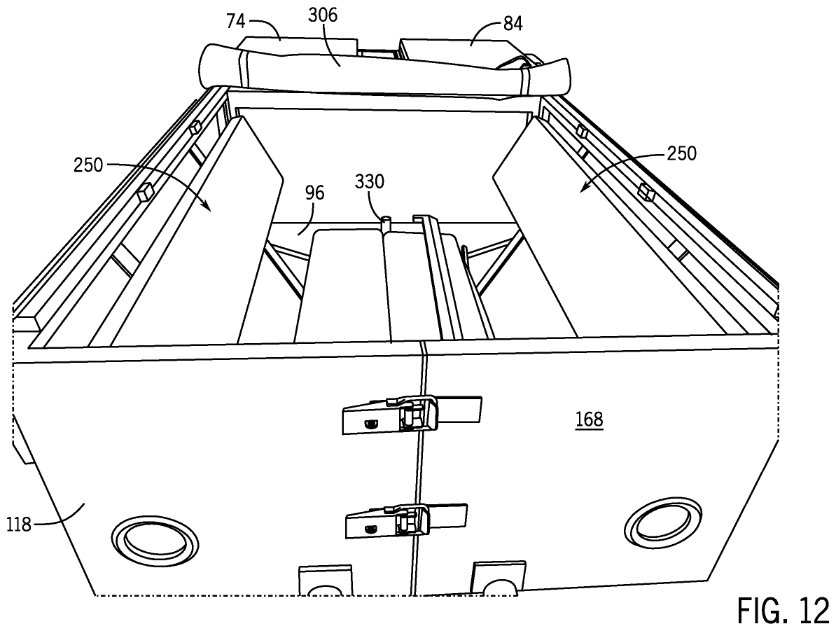

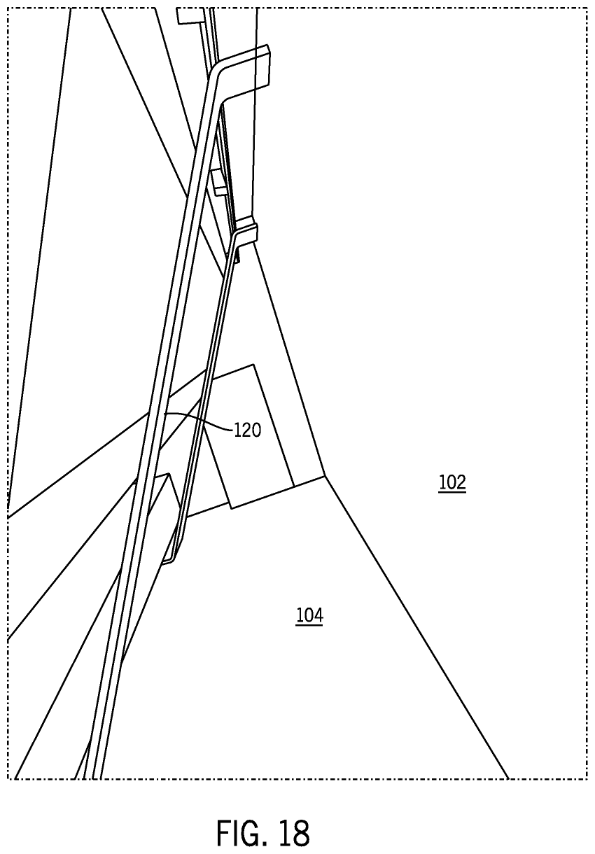

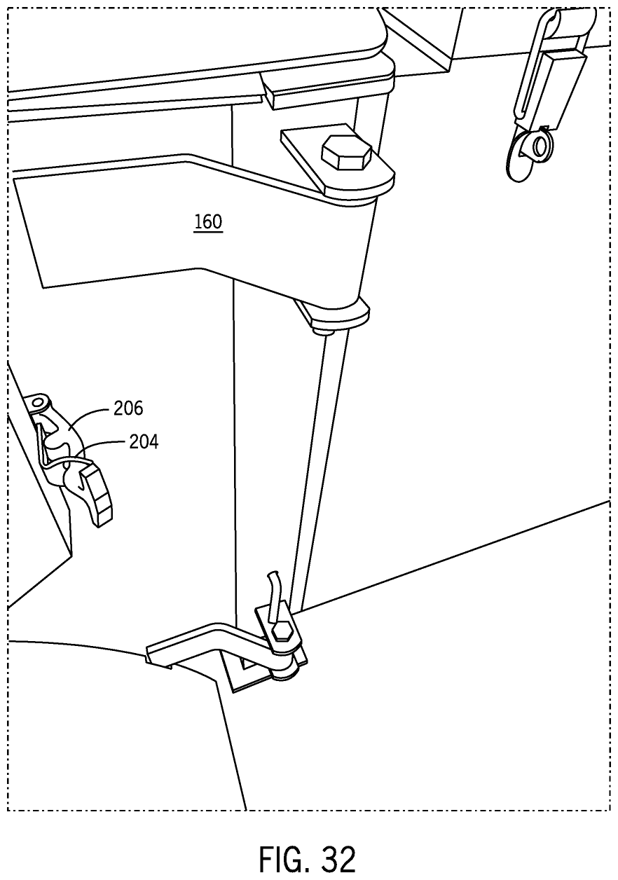

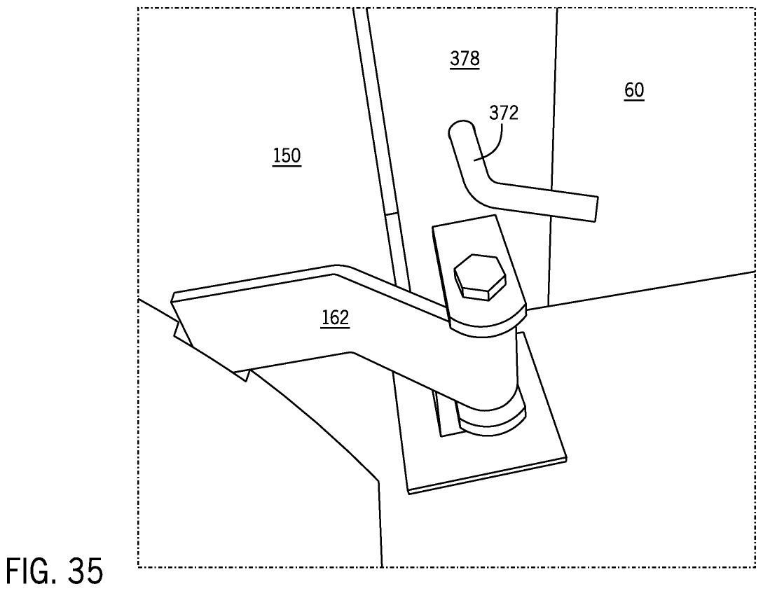

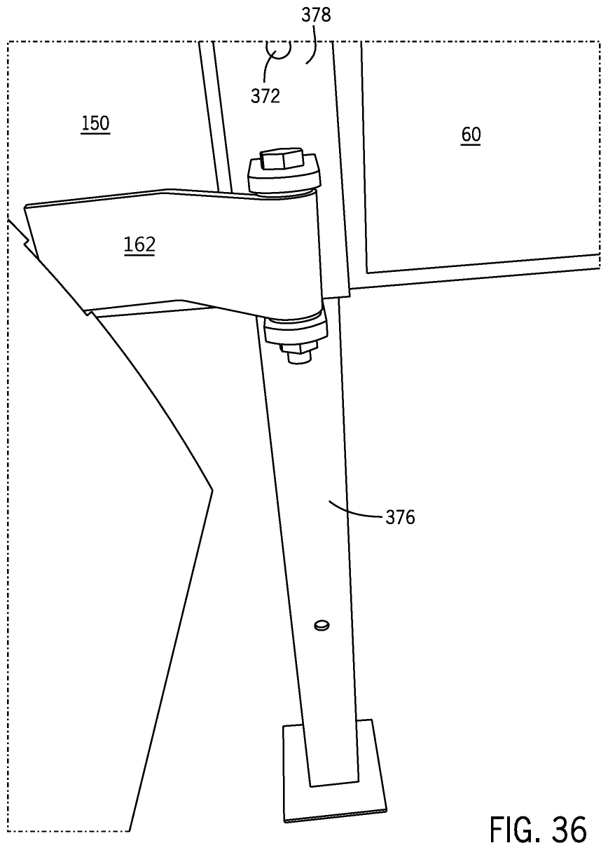

Second section 100 has a longitudinal axis that aligns parallel with the longitudinal axis of the tongue 26. The second section includes a sidewall 102 and flooring 104. Underneath the flooring 104 is a support framework that includes bracing 106 and beams 108 that extend lengthwise. Bracing 106 provides additional support and rigidity for the spindle reinforcement attachment 30. Vertical support 114 extends from the framework and provides structural integrity to the sidewall 102 and hinges 110 and 112. The hinges are spaced apart and pivotally couple the second section 100 to a first end of the front section 60. The hinges are offset such that when the second section 100 pivots open the sidewall 102 doesn't pinch against or contact the front section 60. One end of each hinge 110 and 112 is fixed to vertical support 114 and the other end is fixed to the vertical support 32 fixed to the frame 20 and first section 60 (see also FIGS. 32, 33, 35, and 36). The rear end of the second section 100 is enclosed and a light mount 116 is formed on the end. Also attached to the rear or end 118 of the second section are top and bottom halves 130 and 132 of a latch. Bracket 120 is attached to the interior of the second section 100 and is suitable for supporting a seat 252 and back 254 of bench 250 (see also FIGS. 12, 13, and 18). An inner longitudinal sealing edge 124 extending from flooring 104 includes a stop 126 that presses against the third section 150 when the second and third sections are pivoted closed.

Third section 150 has a longitudinal axis that aligns parallel with the longitudinal axis of the tongue 26. The third section includes a sidewall 152 and flooring 154. Underneath the flooring 154 is a support framework that includes bracing 156 and beams 158 that extend lengthwise. Bracing 156 provides additional support and rigidity for the spindle reinforcement attachment 30. Vertical support 164 extends from the framework and provides structural integrity to the sidewall 152 and hinges 160 and 162. The hinges are spaced apart and pivotally couple the third section 150 to a first end of the front section 60. The hinges are offset such that when the second section 150 pivots open the sidewall 152 doesn't pinch against or contact the front section 60. One end of each hinge 160 and 162 is fixed to vertical support 164 and the other end is fixed to the vertical support 34 fixed to the frame 20 and first section 60 (see also FIGS. 32, 33, 35, and 36). The rear end of the third section 150 is enclosed and a light mount 166 is formed on the end. Also attached to the rear or end 168 of the third section 150 are top and bottom halves 180 and 182 of the latch which mate with the top and bottom halves of the latch attached to the second section 100. Bracket 170 is attached to the interior of the third section and is suitable for supporting the seat 252 and back 254 of bench 250. An inner longitudinal edge 174 along flooring 154 includes a seal that presses against the sealing edge of the second section 100 when the second and third sections are pivoted closed.

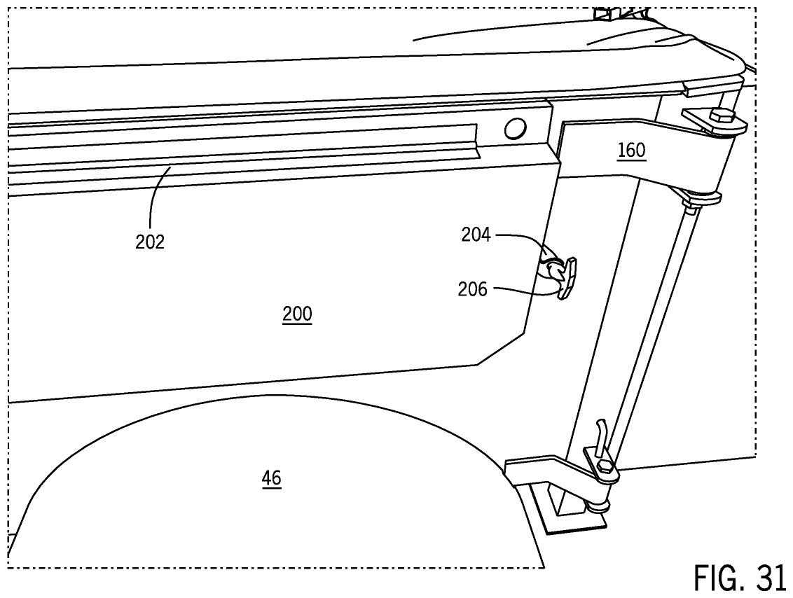

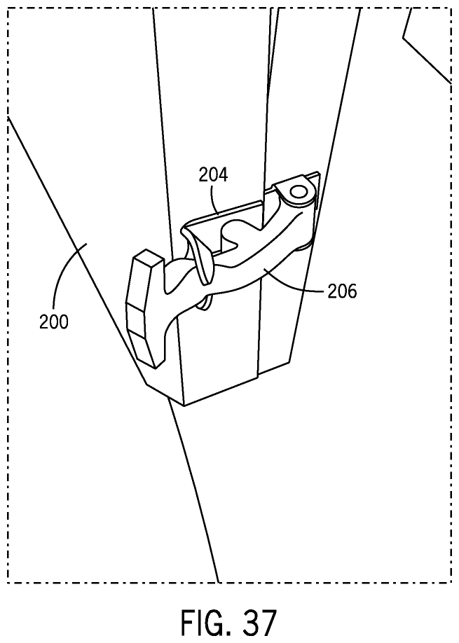

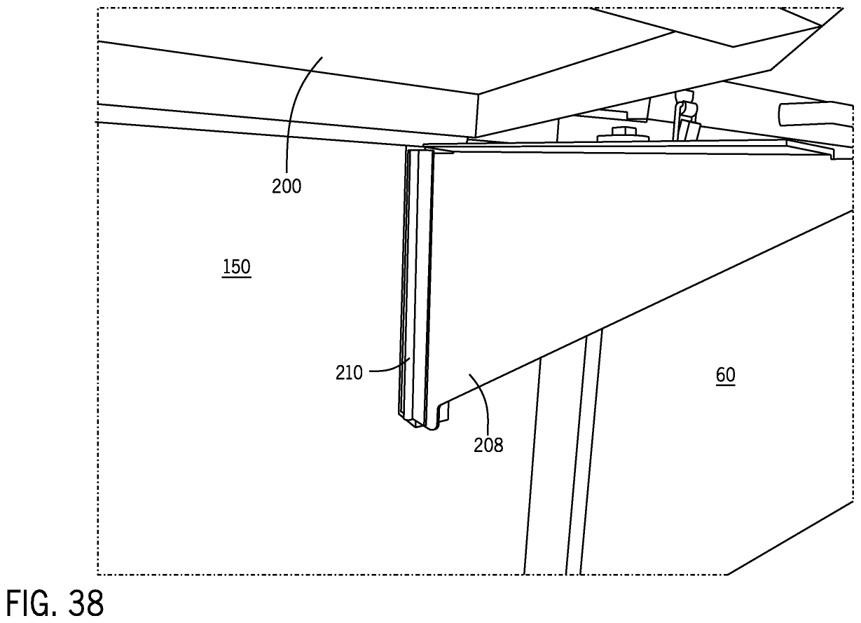

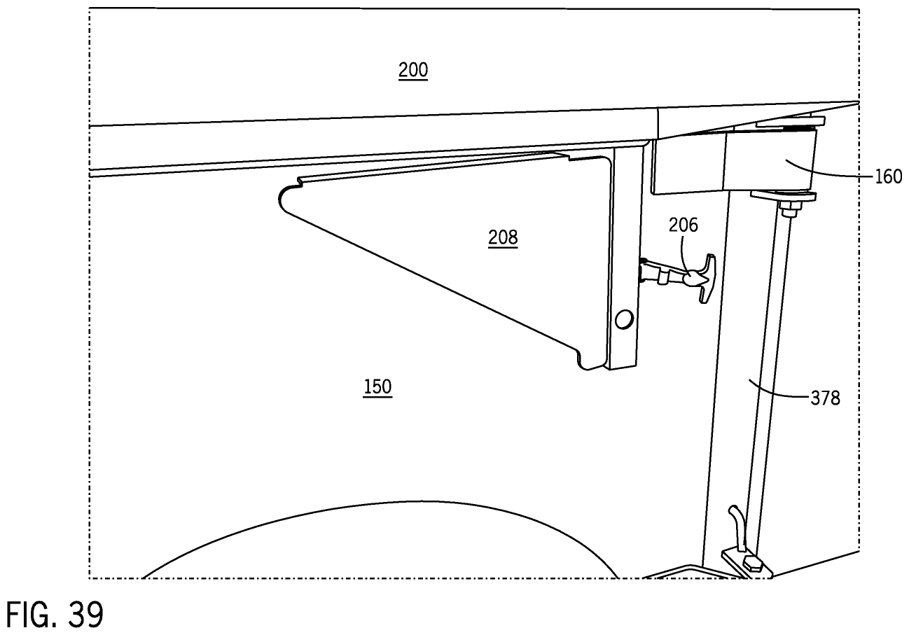

A table 200 is mounted to each outer sidewall 102 and 152 of the second and third sections 100 and 150. Hinge 202 mounts the table to the sidewall and allows the table to pivot between and upright position and a stowed position. When in the stowed position a resilient securing strap 206 attached to the sidewall is stretched and engages a hook 204 attached to the table. In this manner the table 200 is secured in the stowed position. To release the strap, the user simply stretches the strap further and disengages the strap 206 from the hook 204. A folding support 208 is fixed to the sidewall with a hinge 210. When the table is pivoted upward to the upright position the support 208 is pivoted outward to support the underside of the table 200 (see also FIGS. 31, 32, 37, 38, and 39).

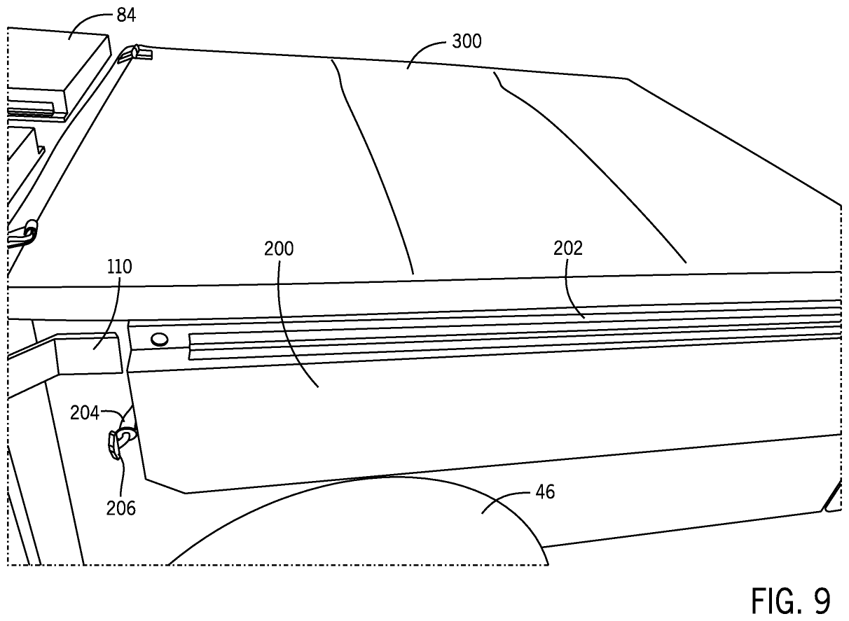

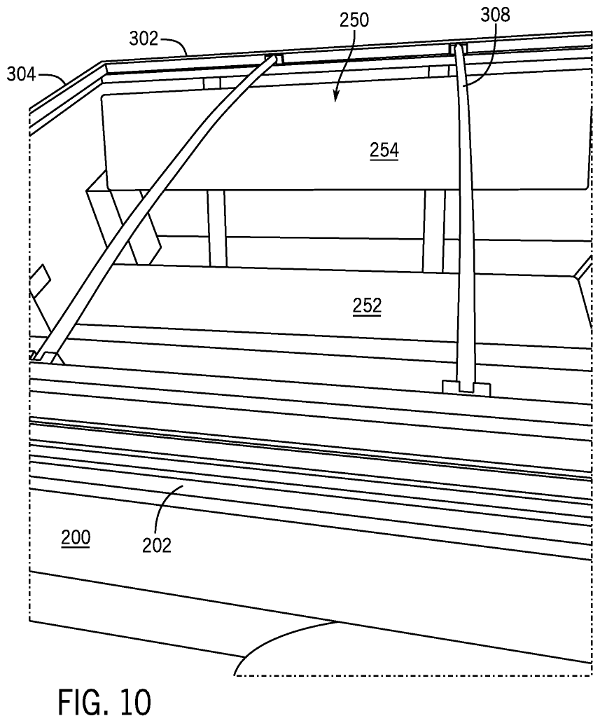

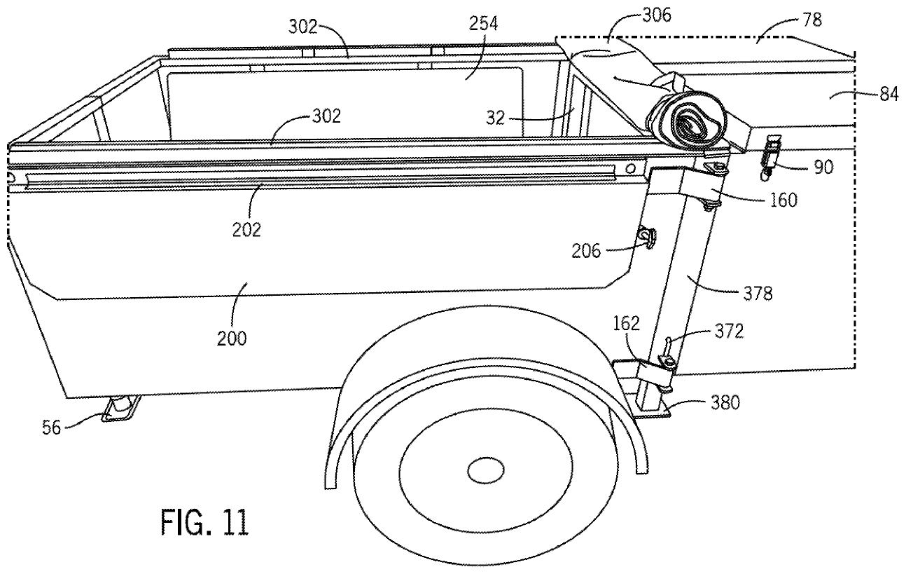

Cover 200 has one end fixed to front section 60 and opposing lengthwise edges engage the top sides of the second and third sections (see also FIG. 9). Siderails 302 are fixed to the sidewalls to engage with the cover. A typical known fasten and loop fastener may be used to engage the cover 300 to the side rails 302. A back rail engages the back ends 118 and 168 of the second and third sections. The free end of the canopy engages to the back rail 304. The canopy 300 may be rolled towards the from to form a canopy roll 306 and expose the interior of the trailer (see also FIG. 11). Bracing 308 may be positioned under the cover 300 to support the cover as air forces the cover down during travel (see also FIG. 10). An umbrella post 330 fixed to inner triangle of the first section may be utilized to secure a picnic umbrella to the trailer (see also FIG. 43).

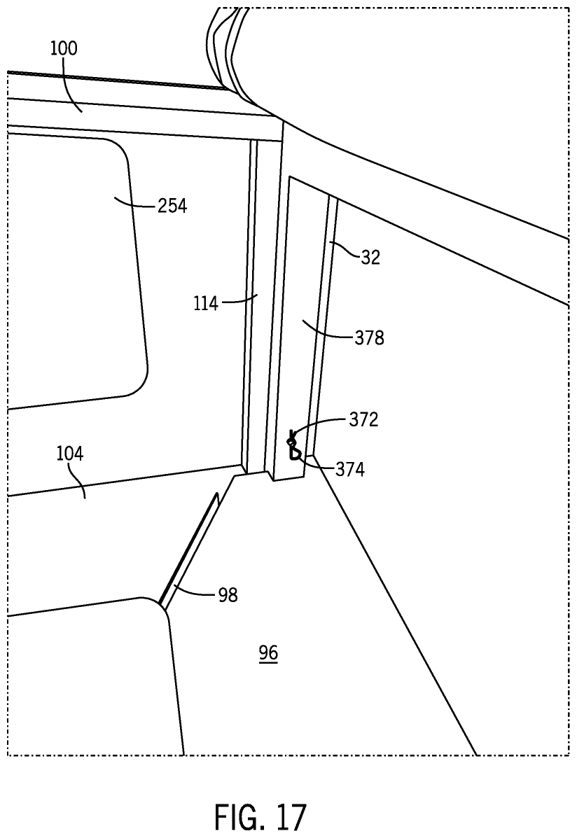

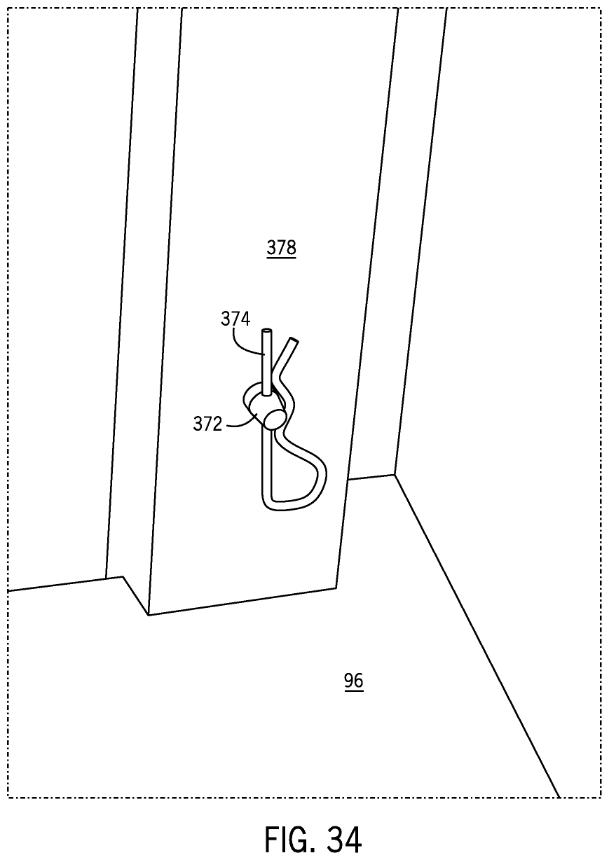

Adjustable height jack stands 370 are mounted to the rear outer ends of the first section 60. The jack stands include an outer tube 378 and inner tube 376. The outer tube includes a single aperture suitable for receiving pin 372. The inner tube includes multiple apertures extending through the tube and spaced along the length of the inner tube. A bottom pad is fixed to a free end of the inner tube. The inner tube 376 is sized to slide within outer tube 378. As the inner tube slides within the outer tube the user may choose and align an aperture of the inner tube with the aperture of the outer tube. When the desired alignment is achieved pin 372 is pressed through both apertures to thereby secure the inner tub within the outer tube. A securing pin 374 may be used to hold pin 372 in place (see also FIGS. 17 and 32-36).

In use, the user may couple the trailer 10 to a vehicle utilizing the hitch 50, safety chains 48 and wiring 352. When the user desires to expand the trailer 10, the trailer is detached from the vehicle and the front jack 52 is pivoted to contact the ground. The jack is extended to lower the rear end of the trailer. The jack stands 370 are then extended so that the pads 380 are in contact or near contact with the ground. The pins 372 are then positioned to fix the height the jack stands 370 are extended. Once the jack stands 370 are fixed the user lowers the front jack 52 to thereby elevate the rear of the trailer. As the rear of the trailer elevates wheels 40 will raise above the ground. Once wheels 40 are no longer contacting the ground the user may disengage latches 130, 132, 180 and 182 and swing the second and third sections 100 and 150 laterally outward. Once the sections have been opened to the desired orientation the rear jacks 56 may be pivoted down and the front jack raised so that the trailer 10 and table 200 are level and the rear jacks contact the ground.

Those skilled in the art will appreciate that modifications may be made to the attachment points, supports, links, braces, couplings and other structure of the trailer without departing from the scope of the invention. By way of example, those skilled in the art will appreciate that additional supports or locking members may be added to the bottom of the frame when the sections are in the stowed or towing position. Further, those skilled in the art will appreciate that additional wheels, dimensional changes, lighting, television, generator, kayak rack, bike rack and other accessories may be added to the trailer 10 without departing from the scope of the invention. Those skilled in the art will further recognize that the trailer 10 may be modified to replace benches with fold out beds to convert the trailer to a camping trailer.

These and various other aspects and features of the invention are described with the intent to be illustrative, and not restrictive. This invention has been described herein with detail in order to comply with the patent statutes and to provide those skilled in the art with information needed to apply the novel principles and to construct and use such specialized components as are required. It is to be understood, however, that the invention can be carried out by specifically different constructions, and that various modifications, both as to the construction and operating procedures, can be accomplished without departing from the scope of the invention. Further, in the appended claims, the transitional terms comprising and including are used in the open ended sense in that elements in addition to those enumerated may also be present. Other examples will be apparent to those of skill in the art upon reviewing this document.

What is claimed is:

1. A device for towing behind a motorized vehicle that expands laterally and contracts longitudinally when in a stationary position, the device comprising:
a front section member having a hitch point for coupling to a vehicle, the front section member having first and second opposing ends wherein a distance between the opposing ends defines a width of the front section member;
a first longitudinal section member pivotally joined to the front section member at the first end of the front section member and at a forward end of the first longitudinal member;
a second longitudinal section member pivotally joined to the front section member at the second end of the front section member and at a forward end of the second longitudinal member;
a first wheel rotationally attached to the first longitudinal section member; and
a second wheel rotationally attached to the second longitudinal section member.

2. The device as recited in claim 1, further including a first bench mounted to the first longitudinal section member.

3. The device as recited in claim 1, further including a second bench mounted to the second longitudinal section member.

4. The device as recited in claim 1, further including a first folding table hingedly mounted to the first longitudinal section member.

5. The device as recited in claim 1, further including a second folding table hingedly mounted to the second longitudinal section member.

6. The device as recited in claim 1, further including a propone cook top mounted to the front section member.

7. The device as recited in claim 1, further including a flexible cover capable of covering a top of both the first and second longitudinal section members when the trailer is in a stowed orientation.

8. The device as recited in claim 1, further including a cooler contained in the front section member.

9. The device as recited in claim 1, further including adjustable height jack stands mounted to the opposing first and second ends of the front section member.

10. A device as recited in claim 1, further including swing jacks mounted to the front and back of the trailer.

11. The device as recited in claim 1, further including an axle-less trailer suspension system coupled between the first wheel and the first longitudinal section member.

12. The device as recited in claim 1, further including an axle-less trailer suspension system coupled between the second wheel and the second longitudinal section member.

13. The device as recited in claim 1, further including latches that secure the first longitudinal section member and the second longitudinal section member together.

14. The device as recited in claim 1, wherein the first and second longitudinal section members include engagement edges to engage together.

15. A device for towing that may expand laterally and contract longitudinally about a pivot when in a stationary position, the device comprising:
a front section member having a towing member extending from a front of the front section member, the front section member having first and second opposing ends wherein a distance between the opposing ends defines a width of the front section member;
adjustable height jack stands mounted to the opposing first and second ends of the front section member;
a first longitudinal section member pivotally joined to the front section member at the first end of the front section member and at a forward end of the first longitudinal member;
a second longitudinal section member pivotally joined to the front section member at the second end of the front section member and at a forward end of the second longitudinal member;
a first wheel rotationally attached to the first longitudinal section member;
a second wheel rotationally attached to the second longitudinal section member;
a first bench mounted to the first longitudinal section member;
a second bench mounted to the second longitudinal section member;
a first folding table hingedly mounted to the first longitudinal section member; and
a second folding table hingedly mounted to the second longitudinal section member.

16. The device as recited in claim 15, further including a propone cook top mounted to the front section member.

17. The device as recited in claim 15, further including a flexible cover capable of covering a top of both the first and second longitudinal section members when the trailer is in a stowed orientation.

18. A device as recited in claim 15, further including swing jacks mounted to the front and back of the trailer.

19. The device as recited in claim 15, further including a first axle-less trailer suspension system coupled between the first wheel and the first longitudinal section member, and a second axle-less trailer suspension system coupled between the second wheel and the second longitudinal section member.

20. The device as recited in claim 15, further including latches that secure the first longitudinal section member and the second longitudinal section member together.
